(19) United States
(12) Patent Application Publication
(10) Pub. No.: US 2023/0168944 A1
(43) Pub. Date: Jun. 1, 2023

(54) SYSTEMS AND METHODS FOR AUTOMATED STAKING MODELS

(71) Applicant: MarketX LLC, Bethesda, MD (US)

(72) Inventors: Michael Joseph KARLIN, Bethesda, MD (US); Daniel Z. ZANGER, San Francisco, CA (US); Ariel Mikhael KATZ, Potomac, MD (US)

(73) Assignee: MarketX LLC, Bethesda, MD (US)

(21) Appl. No.: 17/818,847

(22) Filed: Aug. 10, 2022

Related U.S. Application Data
(60) Provisional application No. 63/283,885, filed on Nov. 29, 2021.

(51) Int. Cl. G06F 9/50; G06N 7/00

(52) U.S. Cl. CPC G06F 9/505; G06N 7/005

(57) ABSTRACT

Methods and systems are described herein for novel uses and/or improvements to blockchain technology. As one example, methods and systems are described herein for facilitating cross-chain processing actions in decentralized networks. One solution to accommodate cross-chain processing actions uses a processing pool, which acts as an intermediary between two blockchain networks. The system and methods described herein further provide a novel model for the operation of self-executing programs for the autonomous execution of the automated processing pool.

### CROSS-REFERENCE TO RELATED APPLICATIONS

This application claims priority to U.S. Patent Application No. 63/283,885, filed Nov. 29, 2021, which is hereby incorporated by reference in its entirety.

### BACKGROUND

Blockchains and blockchain technology, in particular as it relates to decentralized networks, has garnered the attention of technology enthusiasts and laypeople alike. For example, the use of blockchain technology for various applications, including, but not limited to, smart contracts, non-fungible tokens, cryptocurrency, smart finance, blockchain-based data storage, etc. (referred to collectively herein as blockchain applications) has exponentially increased. Each of these applications benefits from blockchain technology that allows for the recording of information that is difficult or impossible to change (either in an authorized or unauthorized manner). For example, a blockchain is essentially a digital ledger of transactions that is duplicated and distributed across the entire network of computer systems on the blockchain. As the blockchain is a decentralized source of information, it does not require a central authority to monitor transactions, maintain records, and/or enforce rules. Instead, technology underlying the blockchain network, which may be specific to each blockchain, namely cryptography techniques (e.g., secret-key, public key, and/or hash functions), consensus mechanisms (e.g., Proof of Work (“POW”), Proof of Stake (“POS”), Delegated Proof of Stake (“dPOS”), Practical Byzantine Fault Tolerance (“pBFT”), Proof of Elapsed Time Broadly (“PoET”), etc.), and computer networks (e.g., peer-to-peer (“P2P”), the Internet, etc.) combine to provide a decentralized environment that enables the technical benefits of blockchain technology.

However, a fundamental problem with blockchain technology is being able to efficiently conduct blockchain processing actions across different blockchain networks. For example, in many instances, a blockchain action and/or a function of a blockchain application may require access to information and/or perform functions using technology specific to a different blockchain network. Blockchain networks and/or blockchain technology as a whole have no native mechanism for handling these cross-chain processing actions.

### SUMMARY

Methods and systems are described herein for novel uses and/or improvements to blockchain technology. As one example, methods and systems are described herein for facilitating processing actions in decentralized networks. One solution to accommodating cross-chain processing actions, uses a processing pool, which acts as an intermediary between two blockchain networks. In conventional systems, these processing pools may be governed by a central authority; however, the use of a central authority to perform cross-chain processing actions mitigates many of the advantages of decentralized networks. As such, the system and methods described herein are described for a cross-chain platform comprising an automated processing pool that facilitates cross-chain processing actions.

However, the creation of a cross-chain platform comprising an automated processing pool that facilitates cross-chain processing actions faces several technical challenges. First, the automated processing pool requires an underlying protocol to facilitate the processing actions. Furthermore, the protocol must facilitate the automated processing pool using autonomous models that do not require any centralized authority to function. One solution for providing this autonomy is through the use of self-executing computer programs (e.g., smart contracts). These self-executing programs may define the models used to facilitate the automated processing pool. These models may include balancing available processing capabilities between a first resource corresponding to a first blockchain network and a second resource corresponding to a second blockchain network.

While the use of self-executing programs may address the need for autonomous execution of the automated processing pool, their use raises an additional technical challenge, namely the conditions and rules defining how the self-executing program operates. This is particularly important as there may be little ability to modify these conditions and/or rules after the launch of the self-executing program.

Accordingly, the system and methods described herein further provide a novel model for the operation of self-executing programs for the autonomous execution of the automated processing pool. Key to this novel model is the use of generalized means (e.g., a parameterized family of averages that extends and generalizes the conventional geometric mean as well as the standard arithmetic mean). For example, the generalized mean may be selected from a family of averages with behavior intermediate between geometric means and arithmetic means. For example, while one approach to the operation of self-executing programs would be to use a constant sum approach to balancing resources across blockchain networks, the use of a constant sum approach leads to inefficiencies in executing the cross-chain processing actions. In contrast, the use of a model based on a generalized means approach does not suffer these inefficiencies.

In some aspects, systems and methods for facilitating cross-chain processing actions in decentralized networks by balancing available processing capabilities using self-executing programs are described. For example, the system may receive, at a cross-chain processing platform, a first request from a first resource provider to contribute first processing capabilities to a first resource of a processing pool of the cross-chain processing platform, wherein the platform facilitates a cross-chain processing action by balancing first available processing capabilities for the first resource and second available processing capabilities for a second resource. The system may, in response to the first request, initiate one or more self-executing programs to determine: a first state of the first available processing capabilities based on a first generalized mean of the first available processing capabilities for first resource and the second available processing capabilities for the second resource at a first time; and a first processing requirement attributed to contributing the first processing capabilities to the first resource, wherein the first processing requirement is based on the first state. The system may execute a first processing action between the first resource provider and the processing pool, wherein an amount attributed to the first processing action is based on an amount of the first processing capabilities and an amount of the first processing requirement, and wherein the first processing action results in the first processing capabilities being added to the first resource.

Various other aspects, features, and advantages of the invention will be apparent through the detailed description of the invention and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows an illustrative diagram of components involved in facilitating processing actions in decentralized network, in accordance with one or more embodiments.

FIG. 2 shows another illustrative example of user interface for generating a plurality of recommendations, in accordance with one or more embodiments.

FIG. 3 shows a machine learning model architecture for facilitating processing actions, in accordance with one or more embodiments.

FIG. 4 shows a system for facilitating processing actions, in accordance with one or more embodiments.

FIG. 5 shows a flowchart for steps involved in facilitating processing actions, in accordance with one or more embodiments.

FIG. 6 shows a flowchart for using a machine learning model for facilitating processing actions, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

Methods and systems are described herein for novel uses and/or improvements to blockchain technology. As one example, methods and systems are described herein for facilitating cross-chain processing actions in decentralized networks. One solution to accommodating cross-chain processing actions, uses a processing pool, which acts as an intermediary between two blockchain networks. An example of such processing pools may include an automated market maker. Current “1.0” automated market makers (“AMMs”) solely depend on liquidity to determine price for tokenized market orders. While this mechanism has been used to launch the decentralized finance (“DeFi”) market, it is inadequate for the future of DeFi.

For example, the system may relate to generating one or more recommendations and/or processing actions that create incentives for use of a pool. By doing so, the incentives may increase a protocol's growth and/or determine the success of the protocol. For example, protocols entice the staking of liquidity tokens in their protocols by rewarding such staking with new tokens. This was done regardless of whether the staking of such tokens in the first place were used in the protocol in a DeFi transaction or merely just added to the protocol (e.g., to assist with price determination and/or to facilitate “market” orders on the protocol).

With the rise of Level 1.0 Blockchain protocols (e.g., Algorand, Cardano, Solana) and 2nd Layer Ethereum protocols (e.g., Polygon), as well as with the conversion of Ethereum to proof-of-stake, the cost to stake on a Blockchain has dropped dramatically and is falling faster. Furthermore, 1.0 AMMs need price arbitrage because they depend on liquidity to determine price. As a result, the DeFi execution on these platforms suffer from lack of optimization due to price inaccuracy from “equilibrium” mismatch, arbitrage, and slippage (e.g., inefficiencies in executing the cross-chain processing actions). In light of the above, the system and methods described herein describe a cross-chain platform (e.g., a decentralized exchange) comprising an automated processing pool (e.g., an AMM) that facilitates cross-chain processing actions (e.g., processing actions involving multiple blockchain networks, blockchain protocols, and/or cryptocurrencies).

For example, the system enables resource providers (e.g., liquidity providers) to stake tokens at a risk of blockchain gas fees for staking, while allowing the resource providers to be “reimbursed” by other users and/or the DeFi Protocol (e.g., the cross-chain platform) if the staked tokens are “taken” by the other users. After tokens are staked, the tokens are presented as bids or offers on the blockchain. If the tokens are “taken” by another user in a processing action (e.g., a DeFi transaction), the resource provider receives rewards for the use of the staked tokens (e.g., rewards paid by the cross-chain platform). The system charges any taker of staked tokens the blockchain gas fees, the cross-chain platform reward, and any additional cross-chain platform fees.

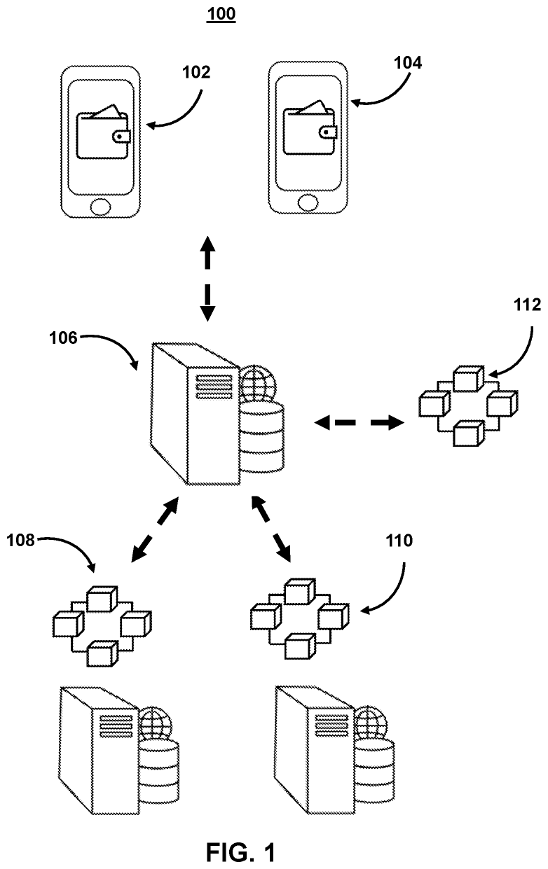

FIG. 1 shows an illustrative diagram for facilitating processing actions (e.g., including cross-chain transactions), in accordance with one or more embodiments. For example, the diagram presents various components that may be used to conduct decentralized actions in some embodiments as the aforementioned embodiments may also be practiced with regards to decentralized technology.

However, the creation of cross-chain platform (e.g., platform 106) comprising an automated processing pool that facilitates cross-chain processing actions faces several technical challenges. First, the automated processing pool requires an underlying protocol to facilitate the cross-chain processing actions. Furthermore, the protocol must facilitate the automated processing pool using autonomous models that do not require any centralized authority to function. One solution for providing this autonomy is through the use of self-executing computer programs (e.g., smart contracts). These self-executing programs may define the models used to facilitate the automated processing pool. These models may include balancing available processing capabilities between a first resource corresponding to a first blockchain network and a second resource corresponding to a second blockchain network.

To achieve these technical benefits, the system (e.g., platform 106) uses an automated processing pool comprising a model that applies processing requirements (e.g., gas fees for a processing action) to the resource providers. For example, whereas a conventional market maker paradigm fails on DeFi because in centralized markets, bidding and offering has no transaction cost (only execution), however on DeFi markets there are gas fees associated with bidding and offering.

For example, DeFi technologies, intended to facilitate a wide range of peer-to-peer financial transactions, rely for their design on blockchain and related distributed ledger technologies, and one of DeFi's core application domains is the Decentralized Exchange (DEX). A principal use case for the DEX platform concept is as a medium for buying and selling cryptocurrencies in which market participants do not require a trusted third party to execute transactions.

Among the most widely-applied types of DEX architectures are those employing Automated Market Maker (AMM) protocols. AMMs utilize liquidity pools instead of a traditional market of buyers and sellers to enable trading of digital assets without intermediaries. The operation of an AMM relies on a trading function, the nature of which governs the trading dynamics of the exchange. An example of the AMM model is the so-called Constant Function Market Maker (CFMM), which employs a suitable invariant mapping as the trading function.

The well-known Uniswap AMM is, in turn, an example of a CFMM for which a constant-product formula is used to define valid transactions for the model. Each trade must be executed in such a way that the quantity removed with respect to one asset in a trade is compensated for by the quantity of the other asset added. Moreover, a trading function defined by means of a (weighted) geometric mean gives rise to a CFMM very closely related to the Constant Product CFMM promulgated by Uniswap. Instead of exploiting a constant product or geometric mean trading function, a constant-sum CFMM approach can, in principle, also be used.

As described herein, the system uses a new form of CFMMs, namely Generalized Mean Market Makers (“G3Ms”) (e.g., as described in Zanger, Daniel Z. (2022) G3Ms: Generalized Mean Market Makers, preprint, which is hereby incorporated by reference in its entirety) whose trading functions are defined in terms of generalized means (e.g., a parameterized family of averages that extends and generalizes the conventional geometric mean as well as the standard arithmetic mean). To define the generalized mean functions, let x₁, . . . , xₙ be n given nonnegative real numbers, and assume that $n$ nonnegative weights satisfying:

w₁+ . . . +wₙ=1 (1)

are also given. Then define the generalized mean at p≠0 via

μₚ(x)=μ_{p,w}(x)=(Σᵢ₌₁ⁿwᵢxᵢ^{p})^{1/p} (2)

where x=(x₁, . . . , xₙ)∈( [symbol] ₊∪{0})ⁿ and w=(w₁, . . . , wₙ)∈( [symbol] ₊∪{0})ⁿ. Moreover, at p=0, define

μ₀(x)=μ_{0,w}(x)=Πᵢ₌₁ⁿxᵢ^{w}^{ᵢ}. (3)

As such, the generalized mean μ₀(x) at p=0 coincides with the (weighted) geometric mean, and, at p=1, the Generalized Mean μ₁(x) coincides with the (weighted) arithmetic mean. The system uses the G3Ms for the intermediate values of p with 0<p<1 to exhibit properties intermediate in a suitable sense between the geometric and arithmetic means and hence to potentially exhibit more favorable behavior as AMMs, at least in some cases, than either of these two end point models can alone.

This technical benefit is supported by the following mathematical observation concerning the generalized means:

lim_{p→0} μ_{p,w}(x)→μ_{0,w}(x) (4)

for any given vectors x=(x₁, . . . , xₙ)∈( [symbol] ₊∪{0})ⁿ and w=(w₀, . . . , wₙ)∈( [symbol] ₊∪{0})ⁿ, where, in (4), the limit is taken from the right (i.e., with respect to p>0). Accordingly, for any such vectors x and w the corresponding generalized mean values at positive values p actually converge in the limit to the associated generalized mean value at 0 (i.e., the corresponding geometric mean) as p→0.

The system may use the G3Ms to execute a trading function of a CFMM. For any positive integer n, consider a basket of n cryptocurrencies, intended for trading, to which is associated a vector [symbol] =(R₁, . . . , Rₙ)∈( [symbol] ₊∪{0})ⁿ, where, here, [symbol] ₊ denotes the set of positive real numbers. The vector [symbol] is called the (cryptocurrency) reserves, and each quantity Rᵢ is the reserve amount—which we think of as being a fixed value—in the exchange of currency i, i=1, . . . n, respectively. We denote by Δ=(Δ₁, . . . , Δₙ)∈( [symbol] ₊∪{0})ⁿ the (cryptocurrency) input trade, so that Δᵢ is the amount of currency i that a trader or market participant proposes to tender or offer to the DEX in exchange for another currency or currencies. Furthermore, the system denotes by Λ=(Λ₁, . . . , Λₙ)∈( [symbol] ₊∪{0})ⁿ the output trade, with Λᵢ being the respective amount of the output trade in currency i, i=1, . . . n, so that Λᵢ will be the amount of currency i that is proposed to be received by the trader from the DEX in return, should the trade be executed.

A trading function, denoted by r, is defined by

τ:( [symbol] ₊∪{0})ⁿ×( [symbol] ₊∪{0})ⁿ×( [symbol] ₊∪{0})ⁿ→R (5)

τ( [symbol] ,Δ,Λ)=μ(R₁+Δ₁−Λ₁, . . . ,Rₙ+Δₙ−Λₙ) (6)

for some given function

μ:( [symbol] ₊∪{0})ⁿ→ [symbol] , (7)

which is considered a legitimate trading function for a CFMM if it is concave, suitably nondecreasing, nonnegative, and differentiable (within the interior of the domain of definition). The Generalized Mean functions μₚ, 0≤p≤1, in (2)-(3) satisfy each of these properties, in particular that of concavity. Additionally the property of (first-order) homogeneity, considered a desirable property for CFMM trading functions to possess, is also satisfied by the Generalized Means (2)-(3).

The trading function r specifies whether a trade is regarded as legitimate and hence may be executed. In the CFMM setting, a proposed trade (Δ, Λ) is legitimate and may be executed if it satisfies:

τ( [symbol] ,Δ,Λ)=τ( [symbol] ,0,0)=C (8)

for some given, fixed C>0. In other words, the trade is accepted only if the trading function is maintained at the constant value=τ( [symbol] , 0, 0)=C. Indeed we can regard a CFMM and corresponding AMM as, in essence, defined by its trading function along with its reserves [symbol] . Our new family of CFMMs, parameterized by p, 0≤p≤1, that we call the G3Ms is therefore defined by taking μ, in (6), respectively to be the generalized mean functions μₚ as in (2)-(3) for 0≤p≤1.

For example, a key metric (i.e., figure of merit) to consider when assessing the effectiveness of different AMM (CFMM) models is the slippage, which is defined as the difference between the expected cost of an order to trade a given asset and the cost actually incurred at the time the order executes. Generally speaking, a slippage relatively low in absolute value is considered more favorable. As is well-known, the Arithmetic Mean CFMM is easily shown to exhibit zero slippage in principle, but, by virtue of the way it is defined mathematically, it can only support trades whose total cost is bounded above by a fixed value. The geometric mean CFMM, on the other hand, can in fact support trades of arbitrarily high cost or value but unfortunately features non-zero slippage.

The significance and usefulness of extending the Arithmetic Mean and Geometric Mean CFMMs as used by the system for intermediate values p, 0<p<1, by means of the G3M model here can in fact be demonstrated in principle. For example, there exists a sequence of G3M models for some values of p, 0<p<1, for which, respectively, valid (buy) trades of arbitrarily large size can be constructed such that corresponding slippage values in these models grow in absolute value significantly more slowly than the respective slippage values do for the Geometric Mean Market Maker model (that is, for the G3M model at p=0). Thus, the G3M models for intermediate values of p, 0<p<1, offer an advantage over the G3M model at p=1 because trades of arbitrarily large size can be supported as p→0, yet, simultaneously, they offer an advantage over the G3M model at p=0 as well due to significantly slower slippage growth.

Furthermore, in some embodiments, the system may generalize the G3M model as described above to the case of CFMMs characterized by trading functions defined by means of a class of functions that extend the Generalized Means. This class of functions extending the Generalized Means is the so-called set of (weighted) Generalized f-Means (GfMs), given by

M_{ƒ,w}(x)=ƒ⁻¹(w₁ƒ(x₁)+= . . . +wₙƒ(xₙ)) (9)

for x=(x₁, . . . , xₙ)∈( [symbol] ₊∪{0})ⁿ and w=(w₁, . . . , wₙ)∈( [symbol] ₊∪{0})ⁿ, as well as a chosen continuous and injective function ƒ mapping an interval I⊆ [symbol] into [symbol] . Here, in (9), “ƒ⁻¹” refers to the inverse function with respect to ƒ, i.e., ƒ⋄ƒ⁻¹=ƒ⁻¹⋄ƒ=Id. The GfM functions as defined by (9) give rise to a class of CFMMs in the same way that the Generalized Means give rise to the G3M models. We can call this more general class of CFMMs the (weighted) Generalized f-Mean Market Makers (Gf3Ms).

The G3M models are special cases of Gf3Ms. The G3M model at each p∈ [symbol] , p≠0, clearly coincides with the Gf3M model for f≡x^{p}, respectively. It is moreover easy to see that the G3M model at p=0 coincides with the Gf3M model for f≡logₑ(x). We note that the Generalized f-Mean is also called the Quasi-Arithmetic Mean as well as the Kolmogorov Mean in the literature. The Gf3Ms can be further extended by means of, for example, the Bajraktarevic or Cauchy Quotient Means, as well as others.

Furthermore, somewhat loosely speaking, Impermanent Loss (also called Divergence Loss) is a metric measuring the possibly temporary loss of asset value suffered by DEX liquidity providers as the values of their assets rise or fall according to DEX-governed trading activity. As such, the system may demonstrate advantages with respect to the G3M models—and the GfM models as well—involving the impermanent loss.

In the present embodiments, these processing requirements are applied to resource providers. For example, as shown in FIG. 1, system 100 may comprise resource provider 102 and resource provider 104. Resource providers may comprise any entity that contributes resources for a processing action and/or facilitates a processing action. As referred to herein, “processing action” may comprise any action including and/or related to blockchains and blockchain technology. For example, processing actions may include conducting transactions, querying a distributed ledger, generating additional blocks for a blockchain, setting rewards and/or incentives for liquidity pools (e.g., in order to dynamically adjust rewards over time to maximize liquidity, minimize slippage, maximize involvement while balancing against expenditure to a certain amount etc.), maximize (or minimize) global states of a system for exchanging cryptocurrencies, generate a fixed token emissions schedule and/or other predetermined emissions schedule, transmitting communications-related nonfungible tokens, performing encryption/decryption, exchanging public/private keys, and/or other operations related to blockchains and blockchain technology. In some embodiments, processing actions may comprise the creation, modification, detection, and/or execution of a smart contract or program stored on a blockchain. For example, a smart contract may comprise a program stored on a blockchain that is executed (e.g., automatically, without any intermediary's involvement or time loss) when one or more predetermined conditions are met. In some embodiments, processing actions may comprise the creation, modification, exchange, and/or review of a token (e.g., a digital asset-specific blockchain), including a nonfungible token. A nonfungible token may comprise a token that is associated with a good, a service, a smart contract, and/or other content that may be verified by, and stored using, blockchain technology.

In some embodiments, processing actions may also comprise actions related to mechanisms that facilitate other processing actions (e.g., actions related to metering activities for processing actions on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every processing action (e.g., computation, data access, transaction, etc.). Each processing action has a predetermined cost in units of gas (e.g., as determined based on a predefined set of rules for the system). When a processing action triggers the execution of a smart contract, the processing action may include an amount of gas that sets the upper limit of what can be consumed in running the smart contract. The system may terminate execution of the smart contract if the amount of gas consumed by computation exceeds the gas available in the processing actions. For example, in Ethereum, gas comprises a mechanism for allowing Turing-complete computation while limiting the resources that any smart contract and/or processing action may consume.

In some embodiments, gas may be obtained as part of a processing action (e.g., a purchase) using a network-specific cryptocurrency (e.g., ether in the case of Ethereum). The system may require gas (or the amount of the network-specific cryptocurrency corresponding to the required amount of gas) to be transmitted with the processing action as an earmark to the processing action. In some embodiments, gas that is earmarked for a processing action may be refunded back to the originator of the processing action if, after the computation is executed, an amount remains unused.

It should also be noted that the embodiments described herein may be used to generate recommendations for processing actions related areas outside of blockchain technology. For example, in some embodiments, a processing action may comprise sales commissions, network loads (e.g., for balancing), trading commissions, government fees, trader rewards for anything dealing with participating or adding value to an exchange, and/or trader rebates for adding liquidity.

As shown in FIG. 1, the processing action may be facilitated based on user devices corresponding to resource provider 102 and resource provider 104. Resource provider 102 and resource provider 104 may comprise multiple user devices and may act as a decentralized market. For example, system 100 may comprise a distributed state machine, in which each of the components in FIG. 1 acts as a client of system 100. For example, system 100 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system.

It should be noted that, while shown as a smartphone in FIG. 1, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments describing system 100 performing processing action may equally be applied to, and correspond to, an individual user device performing the processing action. That is, system 700 may correspond to the user devices (e.g., corresponding to resource provider 102, resource provider 104, or other entity) collectively or individually.

To provide resources, resource provider 102 and resource provider 104 may contribute (or stake) digital assets. As shown in FIG. 1, resource provider 102 and resource provider 104 may comprise respective digital wallets used to perform processing actions and/or contribute to available resources. For example, the digital wallet may comprise a repository that allows users to store, manage, and trade their cryptocurrencies and assets, interact with blockchains, and/or conduct processing actions using one or more applications. The digital wallet may be specific to a given blockchain protocol or may provide access to multiple blockchain protocols. In some embodiments, the system may use various types of wallets such as hot wallets and cold wallets. Hot wallets are connected to the internet while cold wallets are not. Most digital wallet holders hold both a hot wallet and a cold wallet. Hot wallets are most often used to perform processing actions, while a cold wallet is generally used for managing a user account and may have no connection to the internet.

Furthermore, each resource provider (e.g., resource provider 102 and resource provider 104) may include a private key and/or digital signature. For example, system 100 may use cryptographic systems for conducting processing actions. For example, system 100 may use public-key cryptography, which features a pair of digital keys (e.g., which may comprise strings of data). In such cases, each pair comprises a public key (e.g., which may be public) and a private key (e.g., which may be kept private). System 100 may generate the key pairs using cryptographic algorithms (e.g., featuring one-way functions). System 100 may then encrypt a message (or other processing action) using an intended receiver's public key such that the encrypted message may be decrypted only with the receiver's corresponding private key. In some embodiments, system 100 may combine a message with a private key to create a digital signature on the message. For example, the digital signature may be used to verify the authenticity of processing actions. As an illustration, when conducting processing actions, system 100 may use the digital signature to prove to every node in the system that it is authorized to conduct the processing actions.

Resource provider 102 and resource provider 104 may also use their respective digital wallets and private key to contribute resources to platform 106. Resource provider 102 and resource provider 104 may contribute (e.g., stake) digital assets (e.g., tokens). Resource provider 102 and resource provider 104 have taken a risk by doing so, because resource provider 102 and resource provider 104 will be subject to processing requirements (e.g., blockchain gas fees) for staking (e.g., unlike current 1.0 protocols where resource provider 102 and resource provider 104 would be rewarded for staking tokens). The amount of the processing requirement (e.g., a cost of staking) may correspond to “R,” which represents one or more processing requirements.

After tokens are staked by resource provider 102 and resource provider 104, they are presented as bids or offers on the blockchain (e.g., via platform 106). That is, the digital assets are added to the available resources of the processing pool comprising user devices 108 and 110. For example, user device 108 may corresponding to a first resource for a first blockchain network and user device 110 may correspond to a second resource for second blockchain network. The system (e.g., via platform 106) may invoke a model to facilitate processing actions for the processing pool. The model may include balancing available processing capabilities (e.g., the processing capabilities may correspond to staked assets of the respective cryptocurrencies involved in the cross-chain action) between a first resource corresponding to a first blockchain network and a second resource corresponding to a second blockchain network. For example, the first resource may comprise a first set of staked cryptocurrencies corresponding to a first blockchain network, and the second resource may comprise a second set of staked cryptocurrencies corresponding to a second blockchain network.

Notably, the resource providers do not issue market orders, which would remove liquidity. Instead, the resource providers are adding to it with limit prices. For example, if the contributed resources (e.g., tokens staked by resource provider 102) are “taken” by another user in a processing action, the resource provider (e.g., resource provider 102) receives rewards for the use of the contributed resources (e.g., staked tokens). Platform 106 provides the reward (e.g., “X”) to the resource provider (e.g., resource provider 102).

If users do not offer resources (e.g., liquidity) to the system by staking a bid or offer, and instead “hit” the bids or offers of other staked tokens (e.g., removing liquidity and/or using resource capabilities) through use of market orders, that party would be charged the processing requirements (e.g., fees) that include R (e.g., processing requirements attributed to gas fees), X (e.g., processing requirements in the form of a reward for resource provider 102), and “Y” (e.g., a processing requirement attributed to platform 106).

R may be directed to the cryptocurrencies (e.g., Ethereum, Algorand, etc.), while X may be paid by platform 106 to the resource providers (e.g., resource provider 102). As such, X+Y may be paid by the takers of the resource capabilities (e.g., liquidity) to platform 106. In some embodiments, R, X, and Y may be represented by tokens.

As an example, the following would be a net result of the aforementioned model: platform 106 would receive Y; resource provider 102 would profit in the amount of X−R; and a user of the resource capabilities (e.g., a user of the liquidity) would be charged R+X+Y. It should be noted that resource providers are acting like traditional finance market makers, in that trying to maximize profits/minimize risk in exchange for providing liquidity for users wishing to access the resource capabilities of platform 106 (e.g., the available resources in the processing pool) for use in conducting cross-chain processing actions.

System 100 provides the benefits to the blockchain networks as well, as the amount of X+Y in the model is less than the cost to transact on other systems whether by paying the network and/or due to price inefficiencies on other networks (e.g., benefiting users performing processing actions). Additionally, the amount of X−R is greater than the liquidity staking profits on other AMM protocols due to efficiency rewards and compensating for the liquidity provider risk to stake (e.g., R).

In some embodiments, the system may calculate a processing requirement (e.g., whether a gas fee, sales commissions, network loads (e.g., for balancing), trading commissions, government fees, trader rewards for anything dealing with participating or adding value to an exchange, and/or trader rebates for adding liquidity, etc.). To calculate the R, the system may use a formula based on an amount that a resource provider (e.g., liquidity provider) should be willing to provide to render the processing capabilities (e.g., liquidity). The system may determine whether a “fair” arrangement is one which makes the expected gain of entering into the arrangement $0.

As one example (e.g., related to a coin toss game), a player tosses a fair coin once and is then given $2 if the result is heads and $0 if tails. The player's expected gain from this is exactly $1. Hence, the player should be willing to pay $1 (beforehand, presumably) to compensate if this single-coin-toss game is to be considered a fair bet. The fair price to play here is thus exactly $1.

As for the liquidity provider, the corresponding fair price (F) should be:

F=e^{-rT}(pX−R) (10)

In the present case,
Tis the length of the time interval
X is the amount paid out to the resource provider (at the conclusion of the time period) if the processing capabilities (e.g., liquidity) it provides is used
R is the total of all relevant gas fees required to be paid (e.g., paid by the resource provider itself)
p is the probability that the processing capabilities (e.g., liquidity) provided by the resource provider is actually used over the time interval (of length T)
r is the risk-free interest rate

In some embodiments, the system may use a formula for F rewritten as:

e^{-rT}(pX−R)=e^{-rT}(p(X−R)−(1−p)R). (11)

If the processing capabilities (e.g., liquidity) is used (with probability p) then the gain in this situation is X−R, and, if not, the gain (that is, a loss in this case) is then −R (with probability 1−p). Then, the exponential factor e^{-rT} arises from the time value of money (with continuously compounded interest).

Alternatively, if instead the resource provider is not required to pay the gas fees itself, then the corresponding amount in this case is, analogously,

F=e^{-rT}pX. (12)

In some embodiments, the R may not be paid by the resource provider, but rather by the platform, third party(s), and/or a combination of all these parties, whether directly or indirectly (i.e., through insurance or other indirect products), hence the formula above.

In some embodiments, for example, using formula (1) above, the processing capabilities (e.g., liquidity) proffered by the resource provider is either all used or all not used. Extending the use of formula (1) by considering a more general case with respect to which the system assumes that only a portion l of the processing capabilities (e.g., liquidity) available will be used, according to some appropriate, suitably arbitrary probability distribution. So let X=X(l) be the amount paid out to the resource provider paid if a portion l of liquidity is used. X may be a random variable, and thus we can consider its expectation E[X]. As such, an amount corresponding to a F is now given by:

F=e^{-rT}(E[X]−R). (13)

Similarly, the analogue of (13) is:

F=e^{-rT}E[X] (14)

It should also be noted that the embodiments discussed herein may also be applied to proof-of-stake mechanisms. For example, system 100 may further comprise a plurality of nodes for the blockchain network. Each node may correspond to a user device (e.g., user device 108). A node for a blockchain network may comprise an application or other software that records and/or monitors peer connections to other nodes and/or miners for the blockchain network. For example, a miner comprises a node in a blockchain network that facilitates processing actions by verifying processing actions on the blockchain, adding new blocks to the existing chain, and/or ensuring that these additions are accurate. The nodes may continually record the state of the blockchain and respond to remote procedure requests for information about the blockchain.

For example, user device 108 may request a processing action (e.g., conduct a transaction). The processing action may be authenticated by user device 108 and/or another node (e.g., a user device in the community network of system 100). For example, using cryptographic keys, system 100 may identify users and give access to their respective user accounts (e.g., corresponding digital wallets) within system 100. Using private keys (e.g., known only to the respective users) and public keys (e.g., known to the community network), system 100 may create digital signatures to authenticate the users.

Following an authentication of the processing action, the processing action may be authorized. For example, after the processing action is authenticated between the users, system 100 may authorize the processing action prior to adding it to the blockchain. System 100 may add the processing action to one or more blockchains (e.g., blockchain 112). System 100 may perform this based on a consensus of the user devices within system 100. For example, system 100 may rely on a majority (or other metric) of the nodes in the community network to determine that the processing action is valid. In response to validation of the block, a node user device in the community network (e.g., a miner) may receive a reward (e.g., in a given cryptocurrency) as an incentive for validating the block.

To validate the processing action, system 100 may use one or more validation protocols and/or validation mechanisms. For example, system 100 may use a proof-of-work mechanism in which a user device must provide evidence that it performed computational work to validate a processing action and thus this mechanism provides a manner for achieving consensus in a decentralized manner as well as preventing fraudulent validations. For example, the proof-of-work mechanism may involve iterations of a hashing algorithm. The user device that is successful aggregates and records processing actions from a mempool (e.g., a collection of all valid processing actions waiting to be confirmed by the blockchain network) into the next block. Alternatively or additionally, system 100 may use a proof-of-stake mechanism in which a user account (e.g., corresponding to a node on the blockchain network) is required to have, or “stake,” a predetermined amount of tokens in order for system 100 to recognize it as a validator in the blockchain network.

In response to validation of the block, the block is added to blockchain 112, and the processing action is completed. For example, to add the processing action to blockchain 112, the successful node (e.g., the successful miner) encapsulates the processing action in a new block before transmitting the block throughout system 100.

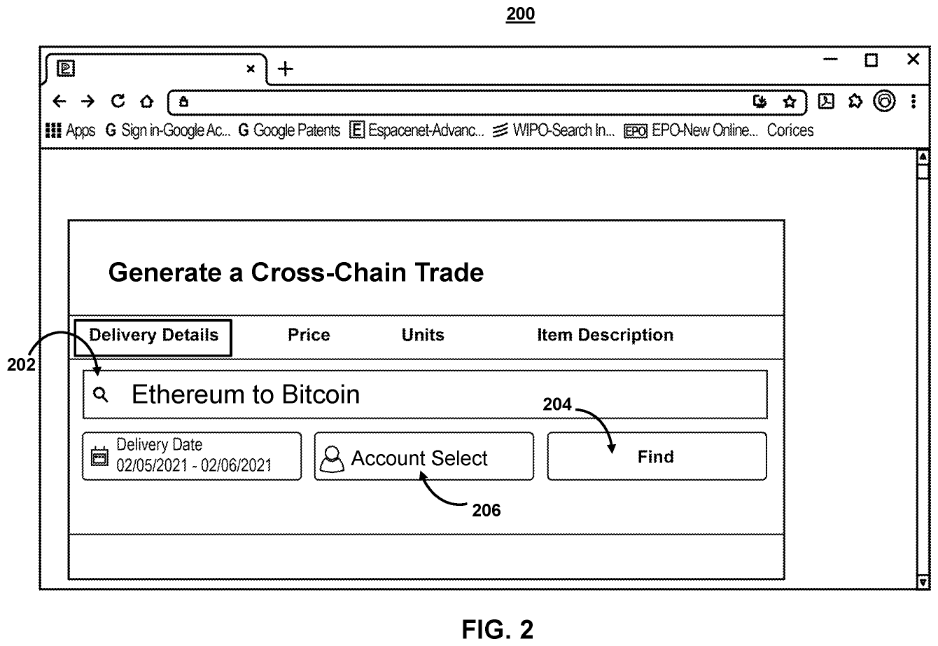

FIG. 2 shows another illustrative example of user interface for generating a plurality of recommendations, in accordance with one or more embodiments. In some embodiments, the system may facilitate cross-chain processing actions in decentralized networks by generating one or more recommendations for a processing action and/or one or more characteristics for a processing action.

For example, resource providers face risks and returns in the aforementioned model (e.g., using system 100 (FIG. 1)) as resources (e.g., tokens) staked by a resource provider are executed in the protocol. The resource may generate a return, but there is risk that their resources (e.g., tokens) are not used and/or executed and the resources could face slippage, impermanentloss, etc. Because of both the potential of risks and returns, the system may generate recommendations related to contributing resources, performing processing actions, etc. For example, the system may generate recommendations that advise on staking protocols to maximize returns (e.g., in exchange for the assessed risk). To generate the recommendations, the system may use algorithms that would include predictions on future supply and demand, temporal strategies to stake, levels of staking to not overly impact the market against the interests of the processing pools, and/or probabilities of execution.

In some embodiments, the recommendation may include amount available to stake, timing periods of when users would want to be involved in the DeFi market to assist in timing and size of staking for predicted price movement, and/or percentage (or other metric) of odds to be executed on a stake. Additionally or alternatively, the system may price out different specific bids and offers and indicate the odds of actual execution in a given time frame.

In some embodiments, the recommendation may concentrate on the inventory risk (e.g., the inventory risk understood to be the possibly fluctuating amount of an asset in question that must be held for any length of time). The system may formulate these recommendations as a Markov decision process (MDP). An MDP may comprise a model for a discrete-time stochastic control process. Under such a conceptualization, the system may generate recommendations corresponding to discrete time steps and/or select prices at which to post limit orders. These recommendations may include recommendations to individual users within the system (e.g., via message on user interface 200) or may include internal system updates ad rule adjustments. As such, the system may use an MDP to facilitate generating recommended bids, offers, and/or other system settings (e.g., reward conditions for the house). For example, the system may use one or more optimization techniques and/or algorithms to dynamically adjust various controllable system parameters (e.g., policies and actions) of the system (e.g., e.g., policies and actions of the owner of the exchange and/or house) to maximize (or minimize) some set of global states. One example is dynamically adjusting rewards (and/or perform other processing actions) over time to maximize liquidity, minimize slippage, maximize involvement while balancing against expenditure to a certain amount etc.

For example, user interface 200 may include field 202. Field 202 may include user prompts for populating a field (e.g., describing the values and/or type of values that should be entered into field 202). As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable content such as audio, video, textual, and/or graphical data. Content may comprise Internet content (e.g., streaming content, downloadable content, webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. For example, content may include one or more recommendations and/or processing actions.

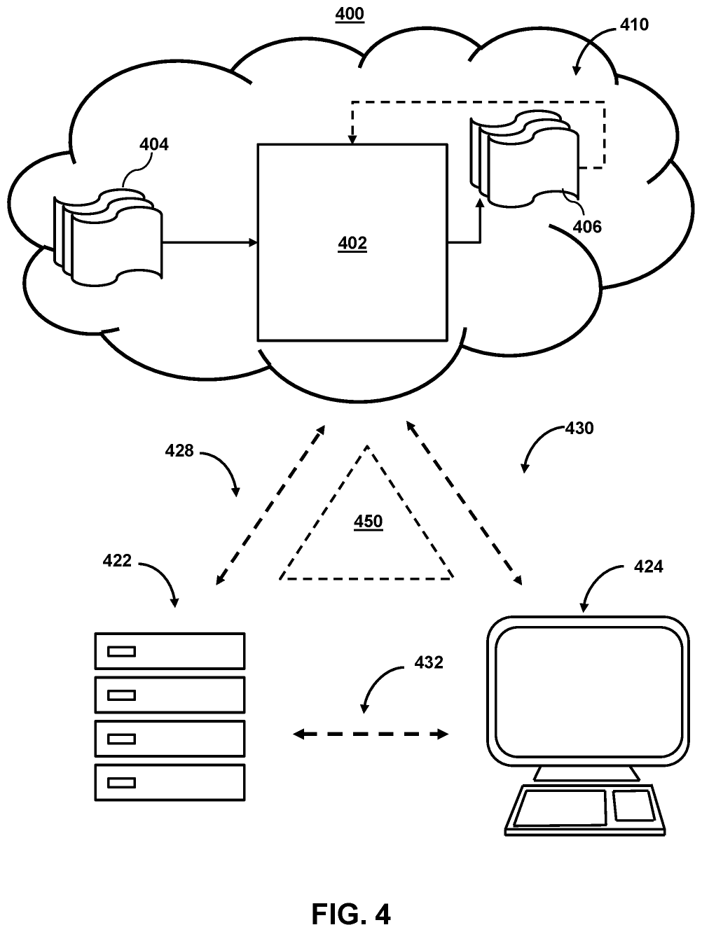

FIG. 2 shows an illustrative example of an application (e.g., a web browser) generating fields for use in generating a plurality of recommendations, in accordance with one or more embodiments. In some embodiments, the application may be provided as part of another application and/or may be provided as a plug-in, applet, browser extension, and/or other software component. In some embodiments, a user interface (and/or components thereof) may be implemented through an API layer (e.g., API layer 450 (FIG. 4)). For example, the application may be part of an application (e.g., a web browser) and/or other program that may be toggled on or off. In another example, the application may be a software component that may be added and/or removed from another application.

In some embodiments, the application may comprise a conceptual data model of the application and/or one or more fields of the application (e.g., the fields currently displayed by the application). For example, the conceptual data model may be a representation of data objects, the associations between different data objects, and/or the rules of the application. In some embodiments, the system may determine a visual representation of the data and apply consistent naming conventions, default values, and semantics to one or more fields in the model. These naming conventions, default values, and semantics of the one or more fields in the model may then be used by the system to generate recommendations for the application. For example, each field may correspond to a category of criteria, characteristics, and/or options. The system may use a field identifier to identify the type of criteria being entered. For example, the system may compare the field identifier to a field database (e.g., a look up table database listing content and/or characteristics of content that correspond to the field) to identify content for a recommendation.

Each field may correspond to criteria for particular information and/or information of a particular characteristic of content. Alternatively or additionally, each field may provide a given function. This function may be a locally performed function (e.g., a function performed on a local device) or this function may be a remotely-executed function. In some embodiments, the function may include a link to additional information and/or other applications, which may be accessed and/or available locally or remotely. In some embodiments, the field may be represented by textual and/or graphical information. For example, a field may comprise a purchasing function through which a user may enter information (e.g., select cryptocurrencies, enter user credential and/or payment account information) that when transmitted may cause a processing action to occur. The system may identify these characteristics and application features for use in generating the conceptual data model.

In some embodiments, the system may detect information about a field of an application (e.g., metadata or other information that describes the field). For example, the information may describe a purpose, functions, origin, creator, developer, a system requirement (including required formats and/or capabilities), author, recommended use, and/or approved user. The information may be expressed in a human-readable and/or computer-readable language or may not be perceivable to a user viewing user interface 200. These fields may be used by the system to match criteria and/or other information submitted by a user and/or by a content provider. For example, in some embodiments, the system may receive content and/or criteria from a plurality of users and/or providers. In some embodiments, these criteria may describe content and/or may describe processing actions related to given content. For example, a first resource provider may enter criteria about a price of content (e.g., a given digital asset) and/or may enter criteria about a first set of delivery terms for the content. A second provider may enter criteria about a second set of delivery terms for the content. A user may then enter criteria about acceptable delivery terms for the content. The system may match each of the received criteria by a field identifier for the content (e.g., a value that uniquely identifies the content and/or characteristics about the content). The system may then make a recommendation related to the content. For example, the system may recommend to the user the content with the first set of delivery terms (as these are better than the second set of delivery terms).

A field may include a field identifier and/or a field characteristic associated with a particular type of data. For example, a field characteristic may be information (e.g., ordering, heading information, titles, descriptions, ratings information, source code data (e.g., HTML, source code headers, etc.), genre or category information, subject matter information, author/actor information, logo data, or other identifiers for the content provider), media format, file type, object type, objects appearing in the content (e.g., product placements, advertisements, keywords, context), or any other suitable information used to distinguish one section from another. In some embodiments, the field characteristic may also be human-readable text. The field characteristic may be determined to be indicative of the field (or content related to the value entered in the field) being of interest to the user based on a comparison of the field characteristic and user profile data for the user.

The information may also include a reference or pointer to user profile information that may be relevant to the selection and/or use of the field. The system may retrieve this information and/or compare it to another field (e.g., a description of acceptable field values) in order to verify, select, and/or use the information. For example, the description may indicate that the field value uses a particular format, falls within a particular range, relates to a particular user, content, user device, and/or user account.

The system may access a user profile. The user profile may be stored locally on a user device (e.g., a component of system 400 (FIG. 4)). The user profile may include information about a user and/or device of a user. For example, the user profile may include information about a digital wallet and/or current asset status of a user. The information may be generated by actively and/or passively monitoring actions of the user. The user profile may also include information aggregated from one or more sources (including third-party sources). The information in the user profile may include personally identifiable information about a user and may be stored in a secure and/or encrypted manner. The information in the user profile may include information about user settings and/or preferences of the user, activity of the user, demographics of the user, and/or any other information used to target a feature towards a user and/or customize features for a user.

Additionally, the user profile may include information about how the user describes his/her preferences, determinations (e.g., via a machine learning model) of how the user describes his/her preferences, how the user's descriptions of preferences match the descriptions of criteria provided by one or more content providers, and/or other information used to interpret criteria and match the criteria to criteria about content available for a recommendation.

In some embodiments, the system may pre-fetch content (or recommendations) as a user navigates and/or user one or more applications. The system may pre-fetch this information based on information in the user profile (e.g., a user preference or setting), a predetermined or standard recommendation selection (e.g., by the application), previously selected content when the application was last used, and/or other criteria. For example, the system may continuously, and in real-time, pre-fetch (or request) content for automatically populating the application and/or user interface 200. The system may continuously pre-fetch this information and/or may push this information to a local user device and/or edge server for immediate use if an application is activated. Accordingly, the system may minimize delays attributed to populating recommendations and attributed to processing time needed by a remote source.

User interface 200 may include field 202. Field 202 may include user prompts for populating a field (e.g., describing the values and/or type of values that should be entered into field 202).

In response to a selection of user prompt 204, the system may generate a request for recommendation (e.g., based on values populated in fields 202 and 206). Alternatively or additionally, in response to a user selection of prompt 204, the system may identify an application shown in user interface 200 and determine whether a field (e.g., field 202 and 206) currently displayed in the user interface corresponds to a predetermined field that is automatically populated by the application. For example, the system may retrieve metadata used to determine a type of field and compare the type to a predetermined type of field that is automatically populated by an overlay application. In response to determining that the field corresponds to a predetermined field, the system may transmit to a remote source (e.g., cloud component 410 (FIG. 4)), a request for supplemental content for populating the field.

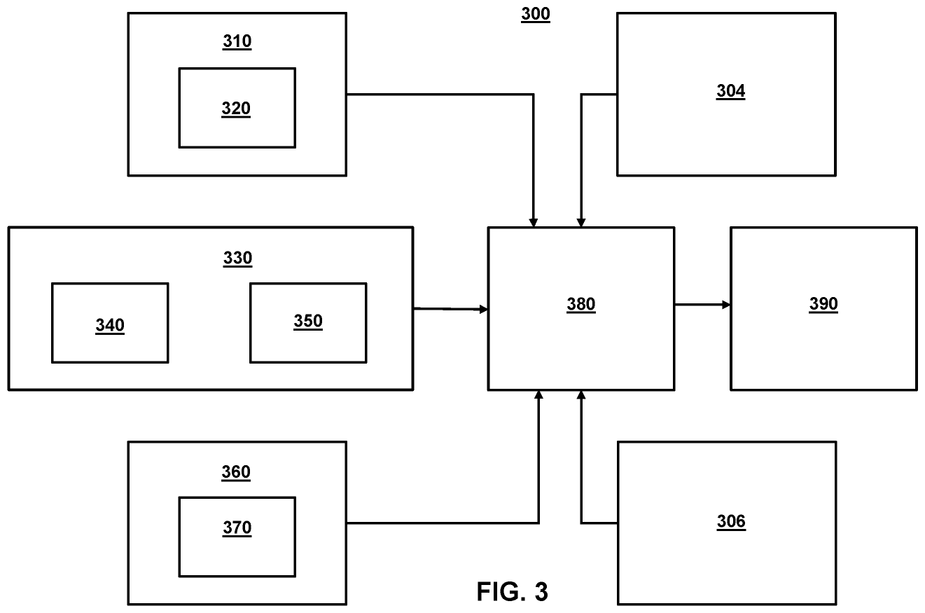

The request may comprise an API request (or call) from one application (e.g., an overlay application implemented on a local device) to an application on a server (e.g., a server implementing system 300 (FIG. 3)). The request may include one or more types of information that may be used by the web server to respond to the request. For example, the request may include information used to select application-specific data, identify an application, and/or determine a field for populating.

For example, in some embodiments, the application may create a library to simplify communicating using API requests and managing user, application, and session data. The system may therefore support multiple data providers and federated routing development, including better management of application/sub-application routing, consistent capture of data, and/or identification of fields. For example, a third-party application may have a field called “paymenttype” and the system may have data for populating payment type information in a record labeled “payTP”. Using the library, the API request may normalize the format in the request.

FIG. 3 shows a machine learning model architecture for facilitating processing actions, in accordance with one or more embodiments. For example, the system may include one or more machine learning models, architectures, and data preparation steps. The system may determine which machine learning model to use for one or more determinations (e.g., how to tag content, how to tag a user, how to interpret user-selected criteria, how to tag a provider, and/or how to interpret provider-selected criteria) used to generate a recommendation. The system may select the machine learning model (e.g., from the plurality of machine learning models) that is best suited for providing the most accurate result. For example, the system may select from various ensemble architectures featuring one or more models that are trained (e.g., in parallel) to provide the most accurate result.

System 300 may include model 304. Model 304 may comprise a machine learning model using content-based filtering (e.g., using item features to recommend other items similar to what users like, based on their previous actions or explicit feedback). System 300 may include model 306. Model 306 may comprise a machine learning model using collaborative filtering (e.g., making automatic predictions (filtering) about the interests of a user by collecting preferences or taste information from many users (collaborating)).

System 300 may include model 310. Model 310 may comprise a machine learning model that uses both content-based and collaborative filtering. For example, in model 310, outputs from model 320 (e.g., a content-based component (e.g., a model using content-based filtering)) may be input into a model using collaborative filtering (e.g., a model using collaborative filtering). System 300 may include model 360. Model 360 may comprise a machine learning model that also uses both content-based and collaborative filtering. For example, in model 360, outputs from model 370 (e.g., a collaborative component (e.g., a model using collaborative filtering)) may be input into a model using content-based filtering (e.g., a model using content-based filtering).

System 300 may include model 330. Model 330 may comprise a machine learning model that uses both content-based and collaborative filtering. For example, in model 330, outputs from both model 340 (e.g., a content-based component (e.g., a model using content-based filtering)) and model 350 (e.g., a collaborative component (e.g., a model using collaborative filtering)) may be input into model 330. For example, model 330 may comprise model 340 and model 350, which are trained in parallel.

Model 330 may use one or more techniques for a hybrid approach. For example, model 330 may weigh outputs from model 340 and model 350 (e.g., a linear combination of recommendation scores). Alternatively or additionally, the system may use a switching hybrid that uses some criterion to switch between recommendation techniques. Switching hybrids may introduce additional complexity into the recommendation process since the switching criteria must be determined, and this introduces another level of parameterization. Alternatively or additionally, the system may use recommendations from model 340 and model 350 presented at the same time. This may be possible where it is practical to make a large number of recommendations simultaneously. Alternatively or additionally, the system may use feature combinations from model 340 and model 350 in which outputs are thrown together into a single model (e.g., model 330). For example, model 340 and model 350 techniques might be merged, treating collaborative information as simply additional feature data associated with each example and using content-based techniques over this augmented data set.

Alternatively or additionally, the system may use a cascade hybrid that involves a staged process because one model refines the recommendations given by another model. The system may also use feature augmentation where an output from one technique is used as an input feature to another. For example, one technique is employed to produce a rating or classification of an item and that information is then incorporated into the processing of the next recommendation technique. Alternatively or additionally, the system may use a model learned by one recommender as input to another (e.g., model 340 becomes an input for model 350).

At model 380, system 300 may receive outputs from one or more of models 304, 306, 310, 330, and 360. Model 380 may determine which of the outputs to use for a determination used to generate a recommendation. For example, if information about content, information about a user, information used to interpret user-selected criteria, information about a provider, and/or information used to interpret provider-selected criteria about content is sparse, the system may select to use a machine learning model that provides more accuracy in data-sparse environments. In contrast, if data is not sparse, the system may select to use a machine learning model that provides the most accurate results irrespective of data sparsity. For example, content-based filtering algorithms (or models heavily influenced by content-based filtering algorithms) provide more accurate recommendations in environments with data sparsity (or for which no training information is available), but content-based filtering algorithms are not as accurate as collaborative filtering algorithms (or models heavily influenced by collaborative filtering algorithms) in environments without data sparsity (or for which training information is available).

In some embodiments, in order to reduce data processing, system 300 may further comprise a cluster layer at model 380 that identifies clusters. For example, the system may group a set of items in such a way that items in the same group (e.g., a cluster) are more similar (in some sense) to each other than to those in other groups (e.g., in other clusters). For example, the system may cluster recommendations (and/or determinations used to generate a recommendation). The system may compare data from multiple clusters in a variety of ways in order to determine a recommendation. In some embodiments, model 380 may also include a latent representation of outputs from models 304, 306, 310, 330, and 360. The system may input a first feature input into an encoder portion of a machine learning model (e.g., model 380) to generate a first latent representation, wherein the encoder portion of the machine learning model is trained to generate latent representations of inputted feature inputs. The system may input the first latent representation into a decoder portion of the machine learning model to generate a first reconstruction of data used to generate recommendations, wherein the decoder portion of the machine learning model is trained to generate reconstructions of inputted feature inputs. The system may then use the latent representation to generate a recommendation. As the latent representation is a dimensionally reduced output, the system reduces the amount of data processed.

Model 380 may be trained to determine which of models 304, 306, 310, 330, and 360 is the most accurate based on the amount of data used for a given determination. Model 380 may then generate output 390. System 300 may then generate a recommendation based on output 390.

In some embodiments, system 300 (and/or one or more models therein) may use reinforcement learning (e.g., in order to generate one or more processing actions and/or recommendations). Reinforcement learning (RL) is a family of machine learning techniques for direct adaptive control. It consists of various data-driven approaches for efficiently solving MDPs from observations and, as such, lends itself particularly well to the problem of optimal market making. RL techniques can readily be applied to the problem of optimizing/maximizing the overall expected liquidity of the system, in particular in the DeFi context. Moreover, it can do this while, for example, discounting liquidity temporally across time (for instance, liquidity sooner might be worth more than liquidity later). For example, the system may use RL to dynamically adjust rewards (and/or perform other processing actions) over time to maximize liquidity, minimize slippage, maximize involvement while balancing against expenditure to a certain amount etc.

In such embodiments, the system may designate an MDP to be a stochastic model with the following elements:
A set S of system states s
A set A of possible agent actions a
A set of system state transition probabilities defined by:

Pₐ(s,s′)=Pₐ(sₜ_{ᵢ}₊₁=s′|sₜ_{ᵢ},aₜ_{ᵢ}=a), (15)
where Pₐ (s, s′) is the probability of transition (at time tᵢ, where the positive integers I index the model's discrete time steps) from state s to state s′ under action a.
A set of specified values for the immediate rewards (or penalties), denoted by R_a (s,s′)∈R, which are respectively obtained by the agent when taking action a while transitioning from state s to state s′.

Moreover, a corresponding (agent) policy is a mapping of the form:

π:A×S→[0,1], (16)

π(a,s)=Pr(aₜ_{ᵢ}=a|sₜ_{ᵢ}=s) for any i. (17)

The goal of the agent in a reinforcement learning setting is to identify an optimal policy that maximizes the expected, discounted cumulative reward (or, if negative, penalty) values overtime:

V_{π}(s)=E[Σᵢ₌₁^{∞}γ^{t}^{ᵢ} rₜ_{ᵢ}|s,π]. (19)

Here, s and π are any state and policy as defined above, rₜ_{ᵢ} is the random reward gained for following action aₜ_{ᵢ}=a at time step tᵢ with probability π=π(a, s) from state s, and γ∈[0,1] is a discount factor which can correspond, for instance, to the time value of money, if appropriate within the model for the application in question. Well-known algorithms exist to solve (or approximately solve) this type of problem which can often work well in practice in many cases.

For example, in a market-making and/or DeFi context, the reward values rₜ_{ᵢ} in Equation (19) above could represent, if desired, the likely new amount of added (or subtracted) liquidity at any particular time step i. Moreover, the discount factor γ∈[0,1] can be included in (19) to weight, if suitable, liquidity higher sooner than liquidity later.

The overall goal of this system is to improve systemic profits to all parties involved, by increasing price accuracy and efficiency of the use of tokens in actual DeFi transactions through recognizing used liquidity versus staked liquidity for price, execution, and reward. This will provide more value for all parties involved.

The system may also apply to impermanent loss, which happens when liquidity is added to a liquidity pool, and the price of the deposited assets changes compared to when the assets were deposited. The larger this change is, the more the assets are exposed to impermanent loss. In this case, the loss means less dollar value at the time of withdrawal than at the time of deposit. Pools that contain assets that remain in a relatively small price range will be less exposed to impermanent loss. Stablecoins or different wrapped versions of a coin, for example, will stay in a relatively contained price range.

FIG. 4 is an exemplary system diagram for facilitating processing actions in decentralized networks. It should be noted that the methods and systems described herein may be applied to any goods and/or services. While the embodiments are described herein with respect to processing actions, it should be noted that the embodiments herein may be applied to any content. Furthermore, the term recommendations should be broadly construed. For example, a recommendation may include any human or electronically consumable portion of data. For example, the recommendations may be displayed (e.g., on a screen of a display device) as media that is consumed by a user and/or a computer system.

As shown in FIG. 4, system 400 may include server 422 and user terminal 424 (which in some embodiments may correspond to a personal computer). While shown as a server and personal computer, respectively, in FIG. 4, it should be noted that server 422 and user terminal 424 may be any computing device, including, but not limited to, a laptop computer, a tablet computer, a hand-held computer, other computer equipment (e.g., a server), including “smart,” wireless, wearable, and/or mobile devices. FIG. 4 also includes cloud components 410. Cloud components 410 may alternatively be any computing device as described above and may include any type of mobile terminal, fixed terminal, or other device. For example, cloud components 410 may be implemented as a cloud computing system and may feature one or more component devices. It should also be noted that system 400 is not limited to three devices. Users may, for instance, utilize one or more devices to interact with one another, one or more servers, or other components of system 400. It should be noted that, while one or more operations are described herein as being performed by particular components of system 400, those operations may, in some embodiments, be performed by other components of system 400. As an example, while one or more operations are described herein as being performed by components of server 422, those operations may, in some embodiments, be performed by components of cloud components 410. In some embodiments, the various computers and systems described herein may include one or more computing devices that are programmed to perform the described functions. Additionally, or alternatively, multiple users may interact with system 400 and/or one or more components of system 400. For example, in one embodiment, a first user and a second user may interact with system 400 using two different components.

With respect to the components of server 422, user terminal 424, and cloud components 410, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 4, both server 422 and user terminal 424 include a display upon which to display data (e.g., as shown in FIG. 1).

Additionally, as server 422 and user terminal 424 are shown as touchscreen smartphones, these displays also act as user input interfaces. It should be noted that in some embodiments, the devices may have neither a user input interface nor displays and may instead receive and display content using another device (e.g., a dedicated display device such as a computer screen and/or a dedicated input device such as a remote control, mouse, voice input, etc.). Additionally, the devices in system 400 may run an application (or another suitable program). The application may cause the processors and/or control circuitry to perform operations related to recommending content. It should be noted that, although some embodiments are described herein specifically with respect to machine learning models, other predictive, statistically-based analytical models may be used in lieu of or in addition to machine learning models in other embodiments.

Each of these devices may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communication networks or combinations of communication networks. Communication paths 428, 430, and 432 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may be a database (tabular or graph) configured to store user data for the system. For example, the database may include user data that the system has collected about the user through prior interactions, both actively and passively. Alternatively, or additionally, the system may act as a clearinghouse for multiple sources of information about the user, available resources, and/or other content. For example, one or more of cloud components 410 may include a microservice and/or components thereof. In some embodiments, the microservice may be a collection of applications that each collect one or more of the plurality of variables.

Cloud components 410 may include model 402, which may be a machine learning model and/or another artificial intelligence model (as described in FIG. 3). Model 402 may take inputs 404 and provide outputs 406. The inputs may include multiple datasets such as a training dataset and a test dataset. Each of the plurality of datasets (e.g., inputs 404) may include data subsets related to user data, original content, and/or alternative content. In some embodiments, outputs 406 may be fed back to model 402 as inputs to train model 402. For example, the system may receive a first labeled feature input, wherein the first labeled feature input is labeled with a known description (e.g., a known recommendation) for the first labeled feature input (e.g., a feature input based on labeled training data). The system may then train the first machine learning model to classify the first labeled feature input with the known description.

In another embodiment, model 402 may update its configurations (e.g., weights, biases, or other parameters) based on the assessment of its prediction (e.g., outputs 406) and reference feedback information (e.g., user indication of accuracy, reference labels, or other information). In another embodiment, where model 402 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, model 402 may be trained to generate better predictions.

In some embodiments, model 402 may include an artificial neural network. In such embodiments, model 402 may include an input layer and one or more hidden layers. Each neural unit of model 402 may be connected with many other neural units of model 402. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 402 may be self-learning and trained, rather than explicitly programmed, and can perform significantly better in certain areas of problem solving, as compared to traditional computer programs. During training, an output layer of model 402 may correspond to a classification of model 402, and an input known to correspond to that classification may be input into an input layer of model 402 during training. During testing, an input without a known classification may be input into the input layer, and a determined classification may be output.

In some embodiments, model 402 may include multiple layers (e.g., where a signal path traverses from front layers to back layers). In some embodiments, back propagation techniques may be utilized by model 402 where forward stimulation is used to reset weights on the “front” neural units. In some embodiments, stimulation and inhibition for model 402 may be more free-flowing, with connections interacting in a more chaotic and complex fashion. During testing, an output layer of model 402 may indicate whether or not a given input corresponds to a classification of model 402 (e.g., an incident).

For example, in some embodiments, the system may train a machine learning model (e.g., an artificial neural network) to detect known descriptions based on a feature input. For example, the system may receive user data (e.g., comprising the variables and categories of variables described in FIGS. 1-2). The system may then generate a series of features inputs based on the training data. For example, the system may generate a first feature input based on training data comprising user data corresponding to a first known error (or error likelihood). The system may label the first feature input with the first known description (e.g., labeling the data as corresponding to a classification of the description).

For example, in some embodiments, the system may train a machine learning model (e.g., an artificial neural network) to determine a recommendation (e.g., related to a processing action). For example, the system may receive a criterion (e.g., a price for an asset on a decentralized exchange). The system may then generate a series of feature inputs based on the criterion. For example, the system may generate a feature input based on training data comprising content corresponding to the model's interpretation of the user's description, and the system may determine a response (e.g., a recommendation of content).

The system may then train a machine learning model to detect the first known content based on the labeled first feature input. The system may also train a machine learning model (e.g., the same or different machine learning model) to detect a second known content based on a labeled second feature input. For example, the training process may involve initializing some random values for each of the training matrices (e.g., of a machine learning model) and attempting to predict the output of the input feature using the initial random values. Initially, the error of the model will be large, but comparing the model's prediction with the correct output (e.g., the known classification), the model is able to adjust the weights and biases values until the model provides the required predictions.

In some embodiments, the system may use one or more modeling approaches, including supervised modeling. Such supervised machine learning approaches such as linear or nonlinear regression, including neural networks and support vector machines, could be exploited to predict these processing requirements should sufficient amounts of training data be available. In particular, processing requirement data can be sequential, time-dependent data, and this means that recurrent neural networks, CNN, and/or transformer specifically, may be highly applicable in this setting for accurate price forecasting. In some embodiments, the system may use a model involving time series prediction and use Random Forest algorithms, Bayesian RNNs, LSTMs, transformer based models, CNNs or other methods, or combinations of two or more of these and the following: Neural Ordinary Differential Equations (NODEs), stiff and non-stiff universal ordinary differential equations (universal ODEs), universal stochastic differential equations (universal SDEs), and/or universal delay differential equations (universal DDEs).

The system may receive user data via a microservice and/or other means. For example, the microservice may comprise a collection of applications that each collect one or more of a plurality of variables. For example, the system may extract user data from an API layer operating on a user device or at a service provider (e.g., via a cloud service accessed by a user). Additionally or alternatively, the system may receive user data files (e.g., as a download and/or streaming in real-time or near real-time).

System 400 also includes API layer 450. For example, in some embodiments, the system may be implemented as one or more APIs and/or an API layer. In some embodiments, API layer 450 may be implemented on server 422 or user terminal 424. Alternatively or additionally, API layer 450 may reside on one or more of cloud components 410. API layer 450 (which may be a REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages including Ruby, Java, PUP, and JavaScript. SOAP Web services have traditionally been adopted in the enterprise for publishing internal services as well as for exchanging information with partners in B2B transactions.

API layer 450 may use various architectural arrangements. For example, system 400 may be partially based on API layer 450, such that there is strong adoption of SOAP and RESTful Web-services, using resources like Service Repository and Developer Portal but with low governance, standardization, and separation of concerns. Alternatively, system 400 may be fully based on API layer 450, such that separation of concerns between layers like API layer 450, services, and applications are in place.

In some embodiments, the system architecture may use a microservice approach. Such systems may use two types of layers: Front-End Layer and Back-End Layer where microservices reside. In this kind of architecture, the role of the API layer 450 may provide integration between Front-End and Back-End. In such cases, API layer 450 may use RESTful APIs (exposition to front-end or even communication between microservices). API layer 450 may use AMQP (e.g., Kafka, RabbitMQ, etc.). API layer 450 may use incipient usage of new communications protocols such as gRPC, Thrift, etc.

In some embodiments, the system architecture may use an open API approach. In such cases, API layer 450 may use commercial or open source API Platforms and their modules. API layer 450 may use a developer portal. API layer 450 may use strong security constraints applying WAF and DDoS protection, and API layer 450 may use RESTful APIs as standard for external integration.

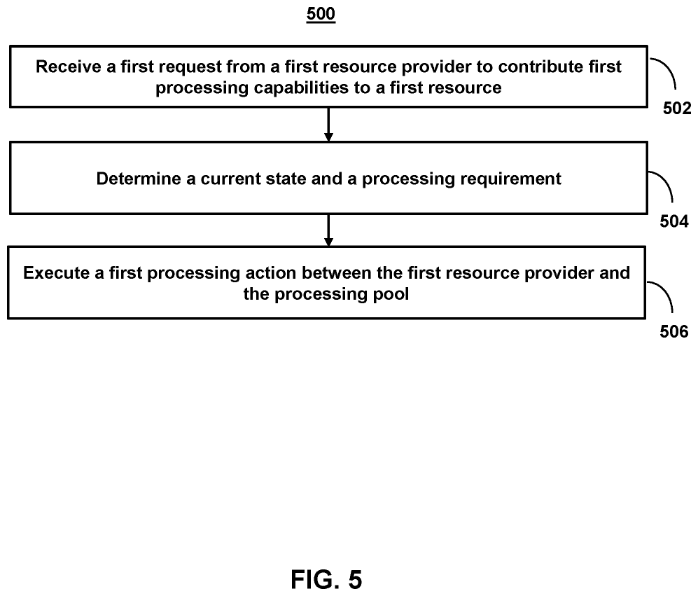

FIG. 5 shows a flowchart of the steps involved in facilitating processing actions in decentralized networks, in accordance with one or more embodiments. For example, the system may use process 500 (e.g., as implemented on one or more system components described above) in order to facilitate cross-chain processing actions in decentralized networks by balancing available processing capabilities using self-executing programs. In some embodiments, process 500 may be used to buy and sell cryptocurrencies.

At step 502, process 500 (e.g., using one or more components described above) receives a first request from a first resource provider to contribute first processing capabilities to a first resource. For example, the system may receive, at a cross-chain processing platform, a first request from a first resource provider to contribute first processing capabilities to a first resource of a processing pool of the cross-chain processing platform, wherein the platform facilitates a cross-chain processing action by balancing first available processing capabilities for the first resource and second available processing capabilities for a second resource.

For example, the processing capabilities may correspond to staked assets of the respective cryptocurrencies involved in the cross-chain action. As such, the system may receive a request to stake an asset. For example, the first resource may be a first type of cryptocurrency and the second resource may be a second type of cryptocurrency.

At step 504, process 500 (e.g., using one or more components described above) determines a current state and a processing requirement. For example, the system may, in response to the first request, initiate one or more self-executing programs (e.g., smart contracts) to determine: a first state of the first available processing capabilities based on a first generalized mean of the first available processing capabilities for the first resource and the second available processing capabilities for the second resource at a first time; and/or a first processing requirement attributed to contributing the first processing capabilities to the first resource, wherein the first processing requirement is based on the first state. The system may determine that the first state is based on the generalized mean. For example, the generalized mean may comprise a parameterized family of averages based on a geometric mean and a standard arithmetic mean and/or a weighted geometric mean and/or a weighted standard arithmetic mean. Additionally or alternatively, the first generalized mean may be based on a class of functions for generalized f-means (“GfMs”).

For example, the current state of the first available processing capabilities corresponds to the current amount/cost attributed to the cryptocurrencies in the pool. As such, the first processing requirement may comprise a gas fee for staking the digital asset. In some embodiments, determining the first state comprises: determining, by the one or more self-executing programs, whether an amount added to the first available processing capabilities for the first resource based on the first processing capabilities corresponds to an amount removed from the second available processing capabilities for the second resource.

In some embodiments, determining the first processing requirement comprises determining a length of a time interval for which the first processing capabilities are contributed to the first resource, determining a probability that the first processing capabilities are used, and determining the first processing requirement that comprises determining a total amount of gas fees attributed to the first processing action.

At step 506, process 500 (e.g., using one or more components described above) executes a first processing action between the first resource provider and the processing pool. For example, the system may execute a first processing action between the first resource provider and the processing pool, wherein an amount attributed to the first processing action is based on an amount of the first processing capabilities and an amount of the first processing requirement, and wherein the first processing action results in the first processing capabilities being added to the first resource.

For example, an amount charge to the user (e.g., a resource provider) wishing to stake an asset is based on the amount the user wishes to stake and the gas fee (e.g., the first processing requirement). Upon execution, the amount of the first processing capabilities corresponds to an amount of staked assets and the gas fee. This amount is then transmitted between the first resource provider and the processing pool.

In some embodiments, the system may receive a request from a user wishing to access the available processing capabilities. For example, the system may receive, at the cross-chain processing platform, a second request, from a user, to access the first processing capabilities at the first resource. In response to the second request, the system may initiate the one or more self-executing programs to determine a second state of the first available processing capabilities based on a second generalized mean of the first available processing capabilities for the first resource and the second available processing capabilities for the second resource at a second time. The system may also determine the first processing requirement attributed to contributing the first processing capabilities to the first resource (e.g., a gas fee paid by the first resource provider). The system may also determine a second processing requirement, wherein the second processing requirement is for the first resource provider. For example, the second processing requirement may comprise a reward issued to the first resource provider for staking the asset. The system may also determine a third processing requirement, wherein the third processing requirement is for the cross-chain processing platform. For example, the third processing requirement may be a fee paid to the platform.

The system may also execute a second processing action based on the request from the user wishing to access the available processing capabilities. For example, the system may execute a second processing action between the first resource provider and the processing pool, wherein an amount attributed to the second processing action is based on the amount of the first processing capabilities, the amount of the first processing requirement, and an amount of the second processing requirement, and wherein the second processing action results in the first processing capabilities being removed from the first resource. For example, an amount charged to the user wishing to stake (e.g., a resource provider) an asset is based on the amount the user wishes to stake and the gas fee (e.g., the first processing requirement). Additionally or alternatively, the system may execute a third processing action between the processing pool and the user, wherein an amount attributed to the third processing action is based on the third processing requirement.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

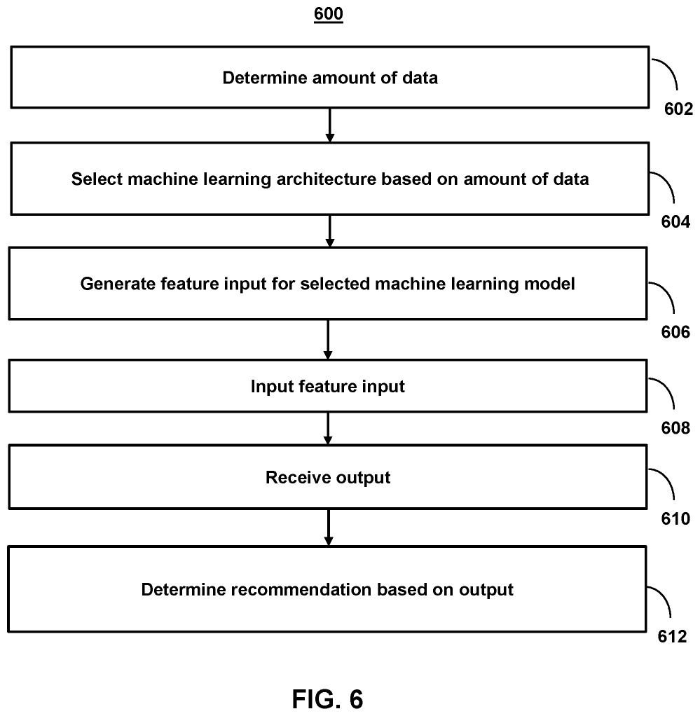

FIG. 6 shows a flowchart for selecting a machine learning model for facilitating processing actions, in accordance with one or more embodiments. For example, the system may use specific algorithms and machine learning models (e.g., as described above in FIGS. 3-5 and below in FIG. 6) that are designed to allow for automatic/systematic optimization of various criteria. For example, a user may input desired criteria (e.g., a processing requirement, gas fee, sales commissions, network loads (e.g., for balancing), trading commissions, government fees, trader rewards for anything dealing with participating or adding value to an exchange, and/or trader rebates for adding liquidity, etc.). In such cases, the system may select a model or a plurality of models for use in generating a processing action and/or recommendation based on a specific objective (e.g., maximizing liquidity, minimizing slippage, etc.) and/or optimizing system settings, rules, and/or polices (e.g., adjusting rewards). For example, the system may select one or more machine learning models to perform one or more optimization techniques and/or algorithms to dynamically adjust various controllable system parameters. As one example, the system may select models comprising and/or otherwise performing functions corresponding to the AMM's discussed above as well as competitive market models and/or empirical experimentation models. For example, competitive market model may comprise a modified Markowitz model which examines the market returns for a given liquidity pool, wherein the empirical experimentation model empirically analyzes the impact of incentive changes (e.g., reward changes). By doing so, the system may statistically model results of incentives (and/or modifications) have on one or more criteria or parameters (e.g., the liquidity of a pool).

At step 602, process 600 (e.g., using one or more components described in FIG. 4) determines an amount of data. For example, the system may receive an initial status report of available data required for one or more determinations. The initial status report may indicate an amount of data (e.g., training data), an amount of training a given model has had, or a confidence level in the model (e.g., a confidence that the model accurately determines the determination). Additionally or alternatively, the system may use information filtering and information retrieval systems rely on relevant feedback to capture an appropriate snapshot of a current state in which the processing action will occur.

At step 604, process 600 (e.g., using one or more components described in FIG. 4) selects a machine learning architecture based on the amount of data. For example, the system may select a machine learning model from a plurality of machine learning models (e.g., the plurality of machine learning models described in FIG. 3). The machine learning models may use Bayesian classifiers, decision tree learners, decision rule classifiers, neural networks, and/or nearest neighbor algorithms.

At step 606, process 600 (e.g., using one or more components described in FIG. 4) generates feature input for selected machine learning models. For example, the system may generate a feature input with a format and/or values that are normalized based on the model into which the feature input is to be input. For example, in some embodiments, the system may use a latent representation (e.g., as described in FIG. 3), in which a lower dimensional representation of data may be used.

At step 608, process 600 (e.g., using one or more components described in FIG. 4) inputs feature input. For example, the system may input a feature input into a machine learning model. For example, the system may determine a criterion for content recommendations for the user by generating a first feature input for a first machine learning model based on the user preference and the user profile and inputting the first feature input into the first machine learning model to receive the criterion.

At step 610, process 600 (e.g., using one or more components described in FIG. 4) receives output. For example, the system may receive an output from a machine learning model. For example, the output may indicate a determination used to generate a recommendation. For example, each determination (e.g., a gas fee, sales commissions, network loads (e.g., for balancing), trading commissions, government fees, trader rewards for anything dealing with participating or adding value to an exchange, and/or trader rebates for adding liquidity, etc.) may be based on one or more outputs from one or more machine learning models.

At step 612, process 600 (e.g., using one or more components described in FIG. 4) determines a recommendation based on the output. For example, the system may determine a recommendation based on the output from the machine learning model. For example, in response to an output that indicates that processing actions (and/or characteristics thereof) corresponding to the criterion, the system may generate for display a recommendation to the user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-4 could be used to perform one or more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising: receiving, at a cross-chain processing platform, a first request from a first resource provider to contribute first processing capabilities to a first resource of a processing pool of the cross-chain processing platform, wherein the platform facilitates a cross-chain processing action by balancing first available processing capabilities for the first resource and second available processing capabilities for a second resource; in response to the first request, initiating one or more self-executing programs to determine: a first state of the first available processing capabilities based on a first generalized mean of the first available processing capabilities for first resource and the second available processing capabilities for the second resource at a first time; and a first processing requirement attributed to contributing the first processing capabilities to the first resource, wherein the first processing requirement is based on the first state; and executing a first processing action between the first resource provider and the processing pool, wherein an amount attributed to the first processing action is based on an amount of the first processing capabilities and an amount of the first processing requirement, and wherein the first processing action results in the first processing capabilities being added to the first resource.
2. The method of the preceding embodiment, wherein the method is for facilitating cross-chain processing actions in decentralized networks by balancing available processing capabilities using self-executing programs.
3. The method of any preceding embodiment, further comprising: receiving, at the cross-chain processing platform, a second request, from a user, to access the first processing capabilities at the first resource; in response to the second request, initiating the one or more self-executing programs to determine: a second state of the first available processing capabilities based on a second generalized mean of the first available processing capabilities for first resource and the second available processing capabilities for the second resource at a second time; the first processing requirement attributed to contributing the first processing capabilities to the first resource; a second processing requirement, wherein the second processing requirement is for the first resource provider; and a third processing requirement, wherein the third processing requirement is for the cross-chain processing platform.
4. The method of any preceding embodiment, further comprising: executing a second processing action between the first resource provider and the processing pool, wherein an amount attributed to the second processing action is based on the amount of the first processing capabilities, the amount of the first processing requirement, and an amount of the second processing requirement, and wherein the second processing action results in the first processing capabilities being removed from the first resource.
5. The method of any preceding embodiment, further comprising: executing a third processing action between the processing pool and the user, wherein an amount attributed to the third processing action is based on the third processing requirement.
6. The method of any preceding embodiment, wherein the first generalized mean comprises a parameterized family of averages based on a geometric mean and a standard arithmetic mean.
7. The method of any preceding embodiment, wherein the first generalized mean comprises a weighted geometric mean or a weighted standard arithmetic mean.
8. The method of any preceding embodiment, wherein the first generalized mean is based on a class of functions for generalized f-means (“GfMs”).
9. The method of any preceding embodiment, wherein determining the first state comprises: determining, by the one or more self-executing programs, whether an amount added to the first available processing capabilities for the first resource based on the first processing capabilities corresponds to an amount removed from the second available processing capabilities for the second resource.
10. The method of any preceding embodiment, wherein determining the first processing requirement comprises: determining a length of a time interval for which the first processing capabilities are contributed to the first resource; and determining a probability that the first processing capabilities are used.
11. The method of any preceding embodiment, wherein determining the first processing requirement comprises determining a total amount of gas fees attributed to the first processing action.

What is claimed is:

1. A system for facilitating cross-chain processing actions in decentralized networks by balancing processing capabilities for multiple resources using self-executing programs, the system comprising:
one or more processors; and
a non-transitory computer readable medium having instructions recorded thereon that when executed by the one or more processors causes operations comprising:
receiving, at a cross-chain processing platform, a first request from a first resource provider to contribute first processing capabilities to a first resource of a processing pool of the cross-chain processing platform, wherein the platform facilitates a cross-chain processing action by balancing first available processing capabilities for the first resource and second available processing capabilities for a second resource;
in response to the first request, initiating one or more self-executing programs to determine:
a first state of the first available processing capabilities based on a first generalized mean of the first available processing capabilities for first resource and the second available processing capabilities for the second resource at a first time; and
a first processing requirement attributed to contributing the first processing capabilities to the first resource, wherein the first processing requirement is based on the first state; and
executing a first processing action between the first resource provider and the processing pool, wherein an amount attributed to the first processing action is based on an amount of the first processing capabilities and an amount of the first processing requirement, and wherein the first processing action results in the first processing capabilities being added to the first resource.

2. A method for facilitating processing actions in decentralized networks by balancing available processing capabilities using self-executing programs, the method comprising:
receiving, at a processing platform, a first request from a first resource provider to contribute first processing capabilities to a first resource of a processing pool of the processing platform, wherein the platform facilitates a processing action by balancing first available processing capabilities for the first resource and second available processing capabilities for a second resource;
in response to the first request, initiating one or more self-executing programs to determine:
a first state of the first available processing capabilities based on a first generalized mean of the first available processing capabilities for first resource and the second available processing capabilities for the second resource at a first time; and
a first processing requirement attributed to contributing the first processing capabilities to the first resource, wherein the first processing requirement is based on the first state; and
executing a first processing action between the first resource provider and the processing pool, wherein an amount attributed to the first processing action is based on an amount of the first processing capabilities and an amount of the first processing requirement, and wherein the first processing action results in the first processing capabilities being added to the first resource.

3. The method of claim 2, further comprising:
receiving, at the processing platform, a second request, from a user, to access the first processing capabilities at the first resource;
in response to the second request, initiating the one or more self-executing programs to determine:
a second state of the first available processing capabilities based on a second generalized mean of the first available processing capabilities for first resource and the second available processing capabilities for the second resource at a second time;
the first processing requirement attributed to contributing the first processing capabilities to the first resource;
a second processing requirement, wherein the second processing requirement is for the first resource provider; and
a third processing requirement, wherein the third processing requirement is for the processing platform.

4. The method of claim 3, further comprising:
executing a second processing action between the first resource provider and the processing pool, wherein an amount attributed to the second processing action is based on the amount of the first processing capabilities, the amount of the first processing requirement, and an amount of the second processing requirement, and wherein the second processing action results in the first processing capabilities being removed from the first resource.

5. The method of claim 3, further comprising:
executing a third processing action between the processing pool and the user, wherein an amount attributed to the third processing action is based on the third processing requirement.

6. The method of claim 2, wherein the first generalized mean is selected from a family of averages with behavior intermediate between geometric means and arithmetic means.

7. The method of claim 2, wherein the first generalized mean comprises a weighted geometric mean or a weighted standard arithmetic mean.

8. The method of claim 2, wherein the first generalized mean is based on a class of functions for generalized f-means (“GfMs”).

9. The method of claim 2, wherein determining the first state comprises:
determining, by the one or more self-executing programs, whether an amount added to the first available processing capabilities for the first resource based on the first processing capabilities corresponds to an amount removed from the second available processing capabilities for the second resource.

10. The method of claim 2, wherein determining the first processing requirement comprises:
determining a length of a time interval for which the first processing capabilities are contributed to the first resource; and
determining a probability that the first processing capabilities are used.

11. The method of claim 2, wherein determining the first processing requirement comprises determining a total amount of gas fees attributed to the first processing action.

12. A non-transitory, computer-readable medium, comprising instructions that, when executed by one or more processors, cause operations comprising:
receiving, at a processing platform, a first request from a first resource provider to contribute first processing capabilities to a first resource of a processing pool of the processing platform, wherein the platform facilitates a processing action by balancing first available processing capabilities for the first resource and second available processing capabilities for a second resource;
in response to the first request, initiating one or more self-executing programs to determine:
a first state of the first available processing capabilities based on a first generalized mean of the first available processing capabilities for first resource and the second available processing capabilities for the second resource at a first time; and
a first processing requirement attributed to contributing the first processing capabilities to the first resource, wherein the first processing requirement is based on the first state; and
executing a first processing action between the first resource provider and the processing pool, wherein an amount attributed to the first processing action is based on an amount of the first processing capabilities and an amount of the first processing requirement, and wherein the first processing action results in the first processing capabilities being added to the first resource.

13. The non-transitory, computer readable medium of claim 12, wherein the instructions further cause operations comprising:
receiving, at the processing platform, a second request, from a user, to access the first processing capabilities at the first resource;
in response to the second request, initiating the one or more self-executing programs to determine:
a second state of the first available processing capabilities based on a second generalized mean of the first available processing capabilities for first resource and the second available processing capabilities for the second resource at a second time;
the first processing requirement attributed to contributing the first processing capabilities to the first resource;
a second processing requirement, wherein the second processing requirement is for the first resource provider; and
a third processing requirement, wherein the third processing requirement is for the processing platform.

14. The non-transitory, computer readable medium of claim 13, wherein the instructions further cause operations comprising:
executing a second processing action between the first resource provider and the processing pool, wherein an amount attributed to the second processing action is based on the amount of the first processing capabilities, the amount of the first processing requirement, and an amount of the second processing requirement, and wherein the second processing action results in the first processing capabilities being removed from the first resource.

15. The non-transitory, computer readable medium of claim 13, wherein the instructions further cause operations comprising:
executing a third processing action between the processing pool and the user, wherein an amount attributed to the third processing action is based on the third processing requirement.

16. The non-transitory, computer readable medium of claim 12, wherein the first generalized mean comprises a parameterized family of averages based on a geometric mean and a standard arithmetic mean.

17. The non-transitory, computer readable medium of claim 12, wherein the first generalized mean comprises a weighted geometric mean and a weighted standard arithmetic mean.

18. The non-transitory, computer readable medium of claim 12, wherein the first generalized mean is based on a class of functions for generalized f-means (“GfMs”).

19. The non-transitory, computer readable medium of claim 12, wherein determining the first state comprises:
determining, by the one or more self-executing programs, whether an amount added to the first available processing capabilities for the first resource based on the first processing capabilities corresponds to an amount removed from the second available processing capabilities for the second resource.

20. The non-transitory, computer readable medium of claim 12, wherein determining the first processing requirement comprises:
determining a length of a time interval for which the first processing capabilities are contributed to the first resource; and
determining a probability that the first processing capabilities are used.
